(19) United States
(12) Patent Application Publication
(10) Pub. No.: US 2007/0031543 A1
(43) Pub. Date: Feb. 8, 2007

(54) EDIBLE ANTI-MICROBIAL FOOD COATING MATERIALS

(75) Inventors: Gordon R. Huber, Sabetha, KS (US); Bradley S. Strahm, Sabetha, KS (US)

Correspondence Address: BRADLEY S. STRAHM, 1217 MEADOWLARK LANE, SABETHA, KS, 65534, US

(73) Assignee: PHRESH TECHNOLOGIES, LLC, Sabetha, KS (US)

(21) Appl. No.: 11/462,703

(22) Filed: Aug. 5, 2006

Related U.S. Application Data
(63) Continuation of application No. 60/705,801, filed on Aug. 6, 2005.

(51) Int. Cl. A21D 13/00

(52) U.S. Cl. 426/94

(57) ABSTRACT

The invention discloses edible anti-microbial food coating materials whose application to foods such as meat, poultry, seafood, vegetables, cheese, or mushrooms results in a significant reduction in the population of microbial contaminants on the surface of the food product. In addition, the edible anti-microbial food coating materials protect the coated food from further microbial growth or contamination. These edible anti-microbial food coating materials contain materials that impart the anti-microbial characteristics. Ingredients that lower the pH of the coating materials result in coating materials that are anti-bacteria, while ingredients that are preservatives or mold inhibitors result in coating materials that are anti-mold and anti-yeast, The edible anti-microbial coating materials are applied to the surface of the food product in layers which are comprised of one or more of the following: adhering material, predust, batter, and crumbs. In addition, the edible anti-microbial coating materials can be manufactured to have a high water activity which also results in a breading product that browns more evenly and eliminates the known frostiness problem inherent in extruded crumb products.

### BACKGROUND OF THE INVENTION

1. Field of the Invention

The present invention is broadly concerned with edible anti-microbial food coating materials that when applied to foods such as meat, poultry: seafood, dairy products such as cheese, vegetables: or mushrooms, there is a significant reduction in the population of microbial contaminants on the surface of the food product and in addition, the edible anti-microbial coating materials protect the coated food from further microbial growth or contamination. To accomplish the reduction of microbial contaminants and to protect the coated food from further microbial growth or contamination, the coating materials have biocidal or biostatic properties which are imparted to the coating materials by ingredients contained in the coating materials. These ingredients are either artificial or natural ingredients that have modes of action that are anti-bacteria, mold, yeast and other microorganisms.

2. Description of the Related Art

The related art describes edible food coating systems commonly called batters, breadings, and coatings, One review of such coating systems is Kuntz, L. The Great Cover-Up: Batters, Breadings, & Coatings, Food Product Design, April 1997 where several common types of coatings are revealed such as flour breaders, cracker meat breaders: American bread crumbs, and Japanese bread crumbs. The article describes these edible coatings as serving the functions of enhancing taste protecting flavor, texture and appearance: preventing oxidation, limiting moisture and oil transfer, giving freeze/thaw stability and extending shelf life. However, the article makes no mention of these edible coatings having biocidal or biostatic properties.

U.S. Pat. No. 5,753,286 reveals a food having a oil and moisture retarding coating that has a specific formulation for imparting these functions. U.S. Pat. No. 6,162,481 reveals breading crumbs containing a heat setting protein that provides improved textural quality under freeze/thaw cycles. U.S. Pat. No. 6,299,915 reveals a coating formulation that gives longer shelf life by limiting weight loss in the form of moisture. However, the '915 invention does not have anti-microbial properties that could extend shelf-life even further and provide increased food safety.

U.S. Pat. No. 6,923,991 reveals a bactericide solution which can be applied as a solution to the surface of food products and is useful for extending the shelf life of foods such as fruits and vegetables. However, the '991 patent does not mention including this bactericide in an edible food coating that is built up layer-wise on the surface of the food,

Biostatic or biocidal activity can be provided to food products in general by several different mechanisms. The addition of acids to foods to lower the pH of the food is a common method employed in foods to reduce or eliminate bacterial growth, or to actually cause a reduction in bacterial populations. By using acids to reach lower pH levels, foods can be given either partial or complete shelf stability either with or without heat treatment, The United States Food and Drug Administration (FDA) has specific rules that regulate the production of acidified, high water activity foods. These regulations are based on scientific evidence and indicate that foods with pH less than 4.3 can be sufficiently free of bacterial populations to avoid any health issues in consumers.

One of the well-known problems with adding acids is the significant sour taste that is imparted to the food. However, some acids that have a much more neutral, non-sour flavor profile are now available.

While the low pH approach discussed above does not address the issue of mold growth on foods, this problem can be addressed by use of the well-know mold inhibitors commonly used in foods such as the alkali metal sorbates such as potassium sorbate, parabens, etc.

Bread crumb and cracker meal coatings can be made by conventional means or by extrusion processing. A Process Description, Breadings by Extrusion Cooking, written by Wenger Manufacturing, Inc., Sabetha, Kans. describes the extrusion process and equipment used for making these products. The process description describes these products as being dried, inferring that they must be reduced to about 10% moisture content or less (or a water activity of 0.7 or less) in order to be shelf stable. The article does not mention the use of shelf-stable, high moisture bread crumbs as a way to preventing frosty tipping.

### SUMMARY OF THE INVENTION

The present invention provides edible anti-microbial coating materials that when applied to the surface of food products results in the reduction of microbial populations on the surface of the food as well as reduces further growth of microbes or further contamination of the food with microbes. The use of batter and breading systems to coat meat, poultry, seafood, vegetables, and mushrooms is well known in the food industry. It is also well known that these food surfaces are contaminated with bacteria, mold, yeast, and other microbial contaminants that are potentially harmful to consumers. These microbial contaminants come into contact with the foods surface in the environments that typically exist during the growing, harvest, processing, distribution, retail, and final food preparation, After coating, these products are sometimes partially, or completely cooked via a deep fat frying process. Depending on the target market of the food, this frying process may not be sufficient to fully cook and kill any microbial contaminants that were on the surface of the food. By use of the present invention, these microbial contaminants will be reduced or eliminated not only by any heat treatment that is applied to the food, but also by the biocidal or biostatic nature of the coating materials. This provides the consumer with enhanced protection from the harmful, disease causing effects of the microbiological contaminants resulting in greater safety of the food product for consumers.

### BRIEF DESCRIPTION OF THE DRAWING

FIG. 1 shows a food product coated with multiple layers of edible anti-microbial materials.

### DETAILED DESCRIPTION OF THE PREFERRED EMBODIMENT

The present invention is concerned with edible anti-microbial food coating materials. Edible anti-microbial food coating materials are prepared by combining food-grade anti-microbial ingredients with coating formulations that are typically used for coating of battered, battered and breaded, or breaded food products, The invention has wide applicability across a wide gamut of foods, especially those foods where edible coatings are often used such as meat, poultry, seafood, cheese, vegetables and mushrooms. The foods just mentioned are known to have surface microbial contaminants that contribute to food spoilage as well as cause disease in consumers if certain microbial contaminants are present in sufficient populations when the food is consumed. Eliminating these microbial contaminants or reducing the growth of these microbial contaminants is the object of this invention, These foods can also become re-contaminated after they are coated and cooked again resulting in the potential of causing disease in consumers.

Broadly speaking, edible anti-microbial food coating materials can take the form of a pre-dust material, a batter, a crumb, or an adhering agent used to facilitate adherence of one of the afore-mentioned materials to the surface of the food product. A pre-dust material is sometimes called cracker meat and typically has a relative small particle size. The food to be coated is rolled or dusted with this material to enhance adhesion of subsequent layers of coating materials such as a batter and/or crumbs. A bailer is generally formulated to be a flowable material in which the food product is dipped such that a layer of this material adheres to the surface of the food, After dipping in the batter, the food is either cooked—typically via deep-at frying—or is subsequently coated with a crumb material. A crumb is generally an expanded material similar to bread crumbs that is produced either by baking bread and then grinding and drying that baked bread, or by an extrusion process such as that disclosed by U.S. Pat. No. 5,350,585, incorporated by reference herein, The crumb is typically applied either over the top of a liquid adhering coating or over the top of a batter.

Edible anti-microbial food coatings of one of the types mentioned above are prepared with one or more ingredients that give the edible anti-microbial food coatings the anti-microbial effect. To kill bacteria or inhibit bacterial growth the pH of the anti-microbial coating material can be lowered by adding an acidic food ingredient, To kill mold, or to inhibit the growth of mold, a preservative or mold inhibitor is added.

To lower the pH of the anti-microbial food coating material, a food-grade acidulant is used. To achieve optimum control of most bacteria, it is necessary to lower the pH of the edible anti-microbial food coating materials to less that pH 5.0 and in some cases to as low as pH 1.0. The FDA regulations for acidulated, high water activity foods indicate that a pH of less than 4.3 is required. A variety of acidulants can be used in the context of the invention, either alone or in various combinations. One such class of acids are sparingly-soluble Group IIA complexes (“AGIIS”) of the type described in U.S. Pat. No. 6,436,891, incorporated by reference herein and of the type described in U.S. Pat. No. 6,902,753, incorporated by reference herein.

One preferred type of AGIIS complexes are the acidulated calcium sulfates (“ACS”), which are believed to be near-saturated, or super-saturated calcium, sulfate anions, or variations thereof, and/or complex ions containing calcium, sulfates, and/or variations thereof.

Another useful acidulant is a composition of a highly acidic metalated organic acid (“HAMO”) as described in U.S. Pat. No. 6,881,424, incorporated by reference herein and in U.S. Pat. No. 6,808,730, incorporated by reference herein, and in U.S. Pat. No. 6,572,906, incorporated by reference herein. The composition may have a suspension of very fine particles, and it has a monovalent or a polyvalent cation, an organic acid, and an anion of a regenerating acid, such as the anion of a strong oxyacid.

Other useful acidulants include organic or inorganic acids that are preferably blended with the AGIIS or HAMO acidulants already discussed. ACS and other AGIIS complexes are noted for having low taste profiles compared to commonly available organic or inorganic acids and therefore are preferred for making good tasting food products. In addition to good taste, it has also been observed that ACS and other AGIIS complexes do not cause starch to hydrolyze as those skilled in the art expect to see when adding acids to starchy materials. This unexpected result makes acidifying some foods possible that was not previously a possibility.

Still other useful acidulants are materials such as dextrose fermentates also known as cultured dextrose. Dextrose fermentates are particularly desirable because they are considered natural products in addition to their good taste profile.

To kill mold, or to inhibit the growth of mold, a preservative is added. A variety of artificial or natural preservatives or mold inhibitors are useful in the context of the invention. One such class of preservatives is the alkali metal sorbates which are considered to be artificial preservatives. Examples of preservatives in this class are potassium sorbate, and calcium sorbate. Other preservatives include calcium propionate, sodium propionate, and sodium benzoate. In addition to artificial preservatives, many consumers prefer natural preservatives. Examples of materials that fall into this class are materials such as whey fermentate or cultured whey, polylysine, and chitosan. In nearly every case, the combination of both a food grade acid to lower the pH and a mold-inhibiting preservative are required. Most mold inhibiting preservatives have greater effectiveness when they are formulated in conjunction with acids, that is, they work better at lower pH levels.

The process used to manufacture edible anti-microbial food coating materials depends on the type of coating material that is being manufactured. In most cases, process that are typically used for manufacturing the standard non-anti-microbial versions of these coating materials can be used. Food coating products are often described as being based on flour, inferring flour made from wheat. However, they can also include in whole or in part, flours made from the other cereal grains or from protein powders from plant or animal sources.

The manufacture of a predust product may be by either conventional baking means such as a cracker manufacturing process or via extrusion. In either case, the acidulant and preservative can be added into the product by conventional means. The acidulant preferably needs to be added in a quantity sufficient to reach a pH from about 1 to about 5.0, more preferably less than about 4.3. The amount of acidulant required to reach this pH varies depending on the acidulant and the buffering capacity of the other ingredients in the formulation. In the conventional processes used to manufacture predust products, the products are typically produced in a dry form to ensure their shelf stability. However, in the case of this invention, lowering the moisture content to conventional levels is not required since the anti-microbial additives serve to preserve the pre-dust product and make it shelf-stable when conventionally packaged. Similarly, the manufacture of a bread crumb product may be by either conventional means of baking loaves of bread, holding the bread while it stales, and then grinding the bread, and drying the crumb or by extrusion means as generally disclosed in U.S. Pat. No. 5,350,585, incorporated herein by reference. However, in the case of this invention, lowering the moisture content to the levels typically used in either the baking or extrusion process is not required since the anti-microbial additives serve to preserve the crumb product and make it shelf-stable at ambient temperature when conventionally packaged in addition to supplying the anti-microbial properties after applied to the surface of the food as a coating.

As disclosed in the '585 patent, extruded bread crumb products have a historical problem of developing frostiness or whitened outer tips when the coated food is frozen. This is believed to be due to a moisture migration and loss problem, It has also been found that by avoiding the final drying step disclosed in the '585 patent, that the problem of whitened outer tips can be avoided, However, these coating products must be kept refrigerated prior to use and have a short shelf-life. By creating a high moisture, edible, anti-microbial bread crumb as described in this invention which is inherently shelf-stable at ambient temperature, the shelf-life of the high moisture extruded crumbs can be extended. Therefore, the crumbs can either be not dried at all, or can be partially dried and still exhibit both good shelf-stability and good non-whitening properties.

A batter product is generally manufactured by blending dry powders, such as flour, and liquids, such as water or milk, together in a ratio of flour and water that results in a thick slurry. The food products are dipped in this slurry and a layer of the slurry remains on the surface of the meat. Following application of the batter, the food either fried to set the batter, or the food is coated with a bread crumb which adheres to the batter layer.

The edible anti-microbial food coating materials disclosed in this invention can be used in a variety of methods. In general, the food coating is built up in a series of layers with the layers comprised of the following: adhering material, pre-dust, batter, and crumbs. These layers are assembled in a variety of orders with the most common assembly orders as follows:
1. Adhering material+crumbs
2. Predust+batter
3. Predust+batter+crumbs
4. Batter+crumbs

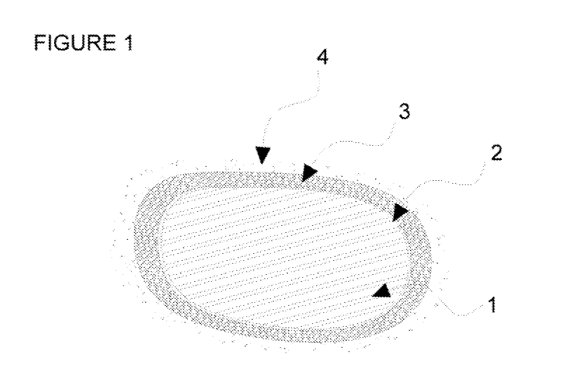

FIG. 1 shows a food product (1) coated with edible anti-microbial materials comprising a combination of predust (2), batter (3) and crumbs (4). Bacteria, mold, and other microorganisms are commonly present on the surface of the food product (1) and will be reduced or eliminated by the biocidal activity of the antimicrobial layers (2) and (3). In addition, the coated food product may be exposed to microorganisms and the edible ant-microbial food coating materials (3) and (4) will prevent contamination of the food product by microorganisms. If microorganisms contact the outer anti-microbial layer, re-contaminating the food, the population is either reduced by the biocidal characteristics of the coating material, or the population cannot grow due to the biostatic characteristics of the coating material.

The preferred embodiment of the present invention is further expressed by the following examples:

### EXAMPLE 1

An antimicrobial food coating material of the expanded bread crumb type was manufactured using the extrusion cooking process. This crumb was prepared by first preparing the following dry blend:

| Ingredient | % |
|---|---|
| Wheat Flour | 95.0 |
| Salt | 1.5 |
| Dextrose | 1.0 |
| Whey | 1.0 |
| Vegetable Shortening | 1.0 |
| Monoglyceride | 0.5 |

In addition, a liquid blend of 15% acidulated calcium sulfate, 5.0 Normal (ACS 50, Mionix Corporation, Rocklin, Calif.) and 85% deionized water was prepared. In addition, a blend of 5.7% postassium sorbate and 94.3% deionized water was prepared. The dry blend was added to the feed hopper of a Wenger TX-52 extrusion system (Wenger Manufacturing, Inc., Sabetha, Kans.) and continuously metered into a Wenger Model 2 DDC preconditioner at a rate of 80 kg/hr. In the preconditioner, water was continuously added at about 25 kg/hr, and the previously described potassium sorbate solution was continuously added at about 52 g/min to achieve about 0.2% potassium sorbate in the products. The previously described acidulated calcium sulfate solution was added at various rates as described below to achieve the target pH of the resulting breading.

From the preconditioner, the breading fell into the extruder barrel where additional water was added at about 5 kg/hr and the co-rotating screws kneaded, heated, and cooked the dough, and forced it through a die opening where the dough was expanded into a bread-like porous structure by steam formation as it exited the die opening. The resulting continuous rope of bread was cut into sections and fed into a bread shredding device to create a bread crumb. The pH of the bread was measured at this point and the rate at which the acidulated calcium sulfate solution was metered into the preconditioner was adjusted to achieve the pH values shown in the table below. The crumb was fed into a Wenger Model 4800 1 section 2 pass dryer where it was dried at 88° C. for 1.6 min to 3.1 minutes to achieve the moisture content and water activity values shown in the table below.

The table below shows the pH, moisture content, and water activity of the several anti-microbial food coating samples produced by the methods described above.

| | | Moisture | Water |
|---|---|---|---|
| Sample ID | pH | content | Activity |
| 901 OD | 5.78 | 12.7% | 0.65 |
| 903 OM | 4.91 | 28.8% | 0.93 |
| 903 OP1 | 4.91 | 24.5% | 0.91 |
| 903 OD | 4.91 | N/A | N/A |
| 904 OP1 | 4.23 | 26.3% | 0.92 |
| 904 OD | 4.23 | N/A | N/A |
| 905 OP1 | 3.99 | 26.5% | 0.92 |

Samples 903 OM, 903 OP1, 904 OP1, and 905 OP1 have water activity levels well about 0.90, yet did not spoil due to mold or bacterial growth for 2 to 5 months after they were prepared while stored at ambient temperature conditions.

The samples of anti-microbial bread crumbs described in this example were applied to food products as a part of a anti-microbial food coating system as described in Examples 6: 7: 9: 10, and 11 described below.

### EXAMPLE 2

An antimicrobial food coating material of the cracker meal bread crumb type was manufactured using the extrusion cooking process. This crumb was prepared by first preparing the following dry blend:

| Ingredient | % |
|---|---|
| Wheat Flour | 96.0 |
| Salt | 4.0 |

In addition, a liquid blend of 15% acidulated calcium sulfate, 5.0 Normal (ACS 50, Mionix Corporation, Rocklin, Calif.) and 85% deionized water was prepared. In addition, a blend of 5.7% postassium sorbate and 94.3% deionized water was prepared. The dry blend was added to the feed hopper of a Wenger TX-52 extrusion system (Wenger Manufacturing, Inc., Sabetha, Kans.) and continuously metered into a Wenger Model 2 DDC preconditioner at a rate of 80 kg/hr. In the preconditioner, water was continuously added at about 25 kg/hr, and the previously described potassium sorbate solution was continuously added at 52 g/min to achieve about 0.2% potassium sorbate in the products. The previously described acidulated calcium sulfate solution was added at various rates as described below to achieve the target pH of the resulting breading.

From the preconditioner, the breading fell into the extruder barrel where additional water was added at about 5 kg/hr, and the co-rotating screws kneaded, heated, and slightly cooked the dough, and forced it through a pair die opening where the dough was extruded into an unexpanded rope. The resulting continuous rope of bread was cut into sections and fed into a bread milling device to create a cracker-like meal. The pH of the dough was measured at this point and the rate at which the acidulated calcium sulfate solution was metered into the preconditioner was adjusted to achieve the pH values of 4.3, 4.8, and 5.2. The crumb was fed into a Wenger Model 4800 1 section 2 pass dryer where it was dried at 88° C. for 1.6 min to 3.1 minutes to achieve the moisture content of about 8%.

### EXAMPLE 3

A batter type food coating material was prepared by blending the ingredients in the proportions shown in the table below to create a viscous batter.

| Ingredient | % |
|---|---|
| Wheat Flour | 31.0 |
| Corn Starch | 6.0 |
| Sodium Bicarbonate | 1.5 |
| Salt | 1.5 |
| Water | 60.0 |

The batter created by blending the Ingredients above has a pH of about 7.5 (control). Sufficient acidulated calcium sulfate, 5.0 Normal (ACS 50, Mionix Corporation, Rocklin, Calif.) was added to the control batter to create anti-microbial batters with pH levels of 4.8 and 4.2.

### EXAMPLE 4

An antimicrobial food coating material of the adhering material type was prepared by adding sufficient acidulated calcium sulfate, 5.0 Normal (ACS 50, Mionix Corporation, Rocklin, Calif.) to a whipped whole egg to achieve a pH of about 4.3.

### EXAMPLE 5

An antimicrobial food coating material of the pre-dust type was prepared by adding about 15% water and sufficient acidulated calcium sulfate, 5.0 Normal (ACS 50, Mionix Corporation, Rocklin, Calif.) to wheat flour to achieve a pH of about 4.4. After blending the flour, water, and acidulated calcium sulfate together, the resulting wetted material was dried at 77° C. for about 15 minutes. After drying it was slightly milled to break up some slight clumps created during the wetting process.

### EXAMPLE 6

A set of control samples and two set of samples having antimicrobial food coating systems were prepared by applying coating materials to the surface of raw chicken breast.

To prepare the control (non anti-microbial) samples, raw chicken breast was first dipped in normal wheat flour, followed by the non-anti-microbial batter described in Example 3, followed by the non-anti-microbial bread crumb described in Example 1. After coating, the chicken having the non-anti-microbial layers was deep fat fried in vegetable oil for about 4 minutes at about 195° C. After frying, the cooked meat with anti-microbial coating was frozen.

A first set of sample having anti-microbial coating materials was prepared by first dipping raw chicken breast in normal wheat flour to assist in adhering the anti-microbial coatings to the exterior of the meat. Then the antimicrobial coating system composed of two layers of anti-microbial coating materials were applied in succession on the outside of the raw chicken dipped in wheat flour. The first layer of the anti-microbial coating system was the anti-microbial batter material described in Example 3 having a pH of 4.8, followed by the anti-microbial bread crumb sample 904 OD described in Example 1 having pH of 4.91. After coating, the chicken having the anti-microbial layers was deep fat fried in vegetable oil for about 4 minutes at about 195° C. After frying, the cooked meat with anti-microbial coating was frozen.

A second set of sample having anti-microbial coating materials was prepared by first dipping raw chicken breast in normal wheat flour to assist in adhering the anti-microbial coatings to the exterior of the meat. Then the antimicrobial coating system composed of two layers of anti-microbial coating materials were applied in succession on the outside of the raw chicken dipped in wheat flour. The first layer of the anti-microbial coating system was the anti-microbial batter material described in Example 3 having a pH of 4.2, followed by the anti-microbial bread crumb sample 903 OD described in Example 1 having pH of 4.23. After coating, the chicken having the anti-microbial layers was deep fat fried in vegetable oil for about 4 minutes at about 195° C. After frying the cooked meat with anti-microbial coating was frozen.

These samples having coatings with a pH of less than 4.3 are considered an acidified food. Foods with pH of 4.3 or less are routinely demonstrated to cause a reduction in microbial populations when inoculated with common food borne pathogens such as Listeria monocytogenes and E. coli. Foods with a pH of greater than 4.3, but less than 5.0 have been shown to have a reduced growth rate of growth of common food bore pathogens.

### EXAMPLE 7

An antimicrobial food coating system was applied to the surface of raw chicken breast. The antimicrobial coating system was composed of two layers of anti-microbial coating materials applied in succession on the outside of the raw chicken. The first layer of the anti-microbial coating system was the anti-microbial adhereing material described in Example 4, followed by the anti-microbial bread crumb sample 904 OD described in Example 1. After coating, the chicken having the anti-microbial layers was deep fat fried in vegetable oil for about 4 minutes at about 195° C. After frying, the cooked meat with anti-microbial coating was frozen.

These edible food coating materials having a pH of about 4.3 or less are considered an acidified food. Foods with pH of 4.3 or less are routinely demonstrated to cause a reduction in microbial populations when inoculated with common food borne pathogens such as Listeria monocytogenes and E. coli.

### EXAMPLE 8

An antimicrobial food coating system was applied to the surface of raw chicken breast. The antimicrobial coating system was composed of two layers of anti-microbial coating materials applied in succession on the outside of the raw chicken. The first layer of the anti-microbial coating system was the anti-microbial predust material described in Example 5 followed by the anti-microbial batter material having pH 4.2 described in Example 3. After coating, the chicken having the anti-microbial layers was deep fat fried in vegetable oil for about 4 minutes at about 195° C. After frying, the cooked meat with anti-microbial coating was frozen.

These edible food coating materials having a pH 4.3 or less are considered an acidified food. Foods with pH of 4.3 or less are routinely demonstrated to cause a reduction in microbial populations when inoculated with common food borne pathogens such as Listeria monocytogenes and E. coli.

### EXAMPLE 9

An antimicrobial food coating system was applied to the surface of raw chicken breast. The antimicrobial coating system was composed of three layers of anti-microbial coating materials applied in succession on the outside of the raw chicken. The first layer of the anti-microbial coating system was the anti-microbial predust material described in Example 5 followed by the anti-microbial batter material having pH 4.2 described in Example 3, followed by the anti-microbial bread crumb material having pH 4.23, designated sample 904OD as described in Example 1. After coating, the chicken having the anti-microbial layers was deep fat fried in vegetable oil for about 4 minutes at about 195° C. After frying, the cooked meat with anti-microbial coating was frozen.

These edible food coating materials having a pH 4.3 or less are considered an acidified food. Foods with pH of 4.3 or less are routinely demonstrated to cause a reduction in microbial populations when inoculated with common food borne pathogens such as Listeria monocytogenes and E. coli.

### EXAMPLE 10

An antimicrobial food coating system was applied to the surface of raw chicken breast. The antimicrobial coating system was composed of four layers of anti-microbial coating materials applied in succession on the outside of the raw chicken. The first layer of the anti-microbial coating system was the anti-microbial adhereing material described in Example 4, followed by the anti-microbial predust material described in Example 5, followed by the anti-microbial batter material having pH 4.2 described in Example 3, followed by the anti-microbial bread crumb material having pH 4.23, designated sample 904OD as described in Example 1. After coating, the chicken having the anti-microbial layers was deep fat fried in vegetable oil for about 4 minutes at about 195° C. After frying, the cooked meat with anti-microbial coating was frozen.

These edible food coating materials having a pH 4.3 or less are considered an acidified food. Foods with pH of 4.3 or less are routinely demonstrated to cause a reduction in microbial populations when inoculated with common food borne pathogens such as Listeria monocytogenes and E. coli.

### EXAMPLE 11

Pieces of raw chicken breast were coated by first dipping in wheat flour, then by dipping in a control batter prepared as described in Example 3, followed by dipping in one of the samples 901 OD, 903 OM, 903 OP1, 904 OP1, and 905 OP1 prepared as described in Example 1. Three pieces of raw chicken breast were coated with each of the expanded crumb samples described above. One of the pieces with each respective coating was fried in vegetable oil at about 195 C. for 4 minutes just after coating. None of these samples exhibited frosty crumb tips and all of them had good, regular flavor. Samples with 903OM, 903 OP1, 904 OP1 and 905 OP1 crumb coatings, which contained acidulated calcium sulfate added during preparation of the crumbs, exhibited much less browning compared to the sample with 901 OD coating which did not contain acidulated calcium sulfate.

The remaining two samples with each coating were then placed in a freezer. After four days, one of each of the pieces with each crumb sample was removed from the freezer and fried in vegetable oil for about 4 minutes at about 195° C. Again, none of the samples exhibited frosty crumb tips. The remaining sample with each coating was returned to the freezer.

After a total of 19 days storage in the freezer, the remaining sample of each crumb type was removed from the freezer and fried in vegetable oil for about 4 minutes at about 195 C. Again, none of the samples exhibited frosty crumb tips.

We claim:

1. An edible anti-microbial food coating forming an integral part of the food and which is optionally created from one or more layers of individual anti-microbial coating materials.

2. The edible anti-microbial food coating of claim 1, said food coating containing sufficient quantity of one or more acids to result in pH less than about 5.

3. The edible anti-microbial food coating of claim 2, said food coating containing a quantity of mold inhibitor

4. The edible anti-microbial food coating of claim 2, one of said acids is acidulated calcium sulfate.

5. The edible anti-microbial food coating of claim 1, one of said individual anti-microbial coating materials is an expanded bread crumb.

6. The edible anti-microbial food coating of claim 5, said expanded bread crumb prepared by the extrusion cooking process.

7. The edible anti-microbial food coating of claim 6, said expanded bread crumb containing a sufficient quantity of one or more acids to result in a pH less than about 5.

8. The edible anti-microbial food coating of claim 7, said expanded bread crumb containing a quantity of mold inhibitor.

9. The edible anti-microbial food coating of claim 7, one of said acids is acidulated calcium sulfate.

10. The edible anti-microbial food coating of claim 5, said expanded bread crumb containing a sufficient quantity of one or more acids to result in pH less than about 5.

11. The edible anti-microbial food coating of claim 10, said bread crumb containing a quantity of mold inhibitor.

12. The edible antimicrobial food coating of claim 10, one of said acids is acidulated calcium sulfate.

13. The edible anti-microbial food coating of claim 1, one of said individual anti-microbial coating materials is a crack meal type crumb.

14. The edible anti-microbial food coating of claim 13, said cracker meal type crumb is prepared by the extrusion cooking process.

15. The edible anti-microbial food coating of claim 14, said cracker meal type crumb containing a sufficient quantity of one or more acids to result in a pH less than about 5.

16. The edible anti-microbial food coating of claim 15, said crack meal type crumb containing a quantity of mold inhibitor.

17. The edible anti-microbial food coating of claim 15, one of said acids is acidulated calcium sulfate.

18. The edible anti-microbial food coating of claim 13, said cracker meal type crumb containing a sufficient quantity of one or more acids to result in pH less than about 5.

19. The edible anti-microbial food coating of claim 18, said cracker meal type crumb containing a quantity of mold inhibitor.

20. The edible anti-microbial food coating of claim 18, one of said acids is acidulated calcium sulfate.

21. The edible anti-microbial food coating of claim 1, one of said individual anti-microbial coating materials is an adhering material.

22. The edible anti-microbial food coating of claim 21, said adhering material containing sufficient quantity of one or more acids to result in pH less than about 5.

23. The edible anti-microbial food coating of claim 22, said adhering material containing a quantity of mold inhibitor.

24. The edible anti-microbial food coating of claim 22, one of said acids is acidulated calcium sulfate.

25. The edible anti-microbial food coating of claim 1, one of said individual anti-microbial coating materials is a batter.

26. The edible anti-microbial food coating of claim 25, said batter containing a sufficient quantity of one or more acids to result in pH less than about 5.

27. The edible anti-microbial food coating of claim 26, said batter containing a quantity of mold inhibitor.

28. The edible anti-microbial food coating of claim 26, one of said acids is acidulated calcium sulfate.

29. The edible anti-microbial food coating of claim 1, one of said individual anti-microbial food materials is a pre-dust material.

30. The edible anti-microbial food coating of claim 29, said pre-dust material containing a sufficient quantity of one or more acids to result in a pH less than about 5.

31. The edible anti-microbial food coating material of claim 30, said pre-dust material containing a mold inhibitor.

32. The edible anti-microbial food coating material of claim 30, one of said acids is acidulated calcium sulfate.

33. A freezable expanded bread crumb prepared by extrusion cooking that does not exhibit frosty tips after freezing and that is shelf stable for at least 3 months at ambient temperature, said freezable expanded bread crumb having moisture content greater than about 12%, water activity greater than about 0.7, and containing one or more acids to result in a pH less than about 5, and containing a quantity of mold inhibitor.

34. The freezable expanded bread crumb of claim 33, said moisture content greater than about 16% and said water activity greater than about 0.8.

35. The freezable expanded bread crumb of claim 34, said moisture content greater than about 18% and said water activity greater than about 0.9.

36. The freezable expanded bread crumb of claim 33, said pH less than about 4.5.

37. The freezable expanded bread crumb of claim 33, one of said acids is acidulated calcium sulfate.
